(19) United States
(12) Patent Application Publication
(10) Pub. No.: US 2014/0269163 A1
(43) Pub. Date: Sep. 18, 2014

(54) Sonar Multi-Function Display With Built-In Chirp Processing

(71) Applicant: Navico, Inc., (US)

(72) Inventor: Alan Proctor, Owasso, OK (US)

(21) Appl. No.: 13/835,885

(22) Filed: Mar. 15, 2013

(51) Int. Cl. G01S 7/04; G01S 15/89

(52) U.S. Cl. CPC G01S 7/04; G01S 15/89
USPC 367/7

(57) ABSTRACT

A CHIRP-enabled sonar system includes a transducer having one or more transducer elements for receiving electrical transmission signals and converting the electrical transmission signals into acoustic pulses, and for receiving echo returns and converting acoustic energy of the echo returns into electrical return signals representative of the echo returns. The system further includes a multi-function display unit connected to the transducer so as to receive the electrical return signals representative of the echo returns. The multi-function display unit has a housing that accommodates a display unit having at least one visual display screen, and also accommodates a processor configured to transmit the electrical transmission signals in the form of CHIRP signals. The processor is further configured to perform CHIRP processing on the electrical return signals to produce sonar data. The display unit is arranged to receive the sonar data and display the sonar data as images on the visual display screen.

### FIELD OF THE INVENTION

Embodiments of the present invention relate generally to sonar systems.

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater. Sonar transducer elements, or simply transducers, may convert electrical energy into sound or vibrations at a particular frequency. A sonar sound beam is transmitted into and through the water and is reflected from objects it encounters. The transducer may receive the reflected sound (the “sonar returns”) and convert the sound energy into electrical energy. Based on the known speed of sound, it is possible to determine the distance to and/or location of the waterborne or underwater objects. The sonar return signals can also be processed to be displayed in graphical form on a display device, giving the user a “picture” of the underwater environment. The signal processor and display may be part of a unit known as a “sonar head” that is connected by a wire to the transducer mounted remotely from the sonar head. Alternatively, the sonar transducer may be an accessory for an integrated marine electronics system offering other features such as GPS, radar, etc.

An acoustic pulse is like an on/off switch modulating the amplitude of a single carrier frequency. The receiver that receives the return from the acoustic pulse does not decode each cycle of the transmitted pulse, but instead produces the envelope of the overall amplitude of the pulse. The ability of monotonic (i.e., single-frequency) acoustic systems to resolve targets is better if the pulse duration is short, but long transmit pulses are preferred to get sufficient acoustic energy into the water for good identification of far-distant target. However, because of the velocity of sound (VOS) through water (typically around 1500 meters/second), each pulse will occupy an equivalent distance related to its pulse duration. More particularly, the range resolution follows the equation Range Resolution=(Pulse Duration×VOS)/2.

In typical monotonic side-scan sonar systems the pulse duration is about 100 micro seconds, and given the typical VOS of 1500 meters/second, a range resolution of 75 mm is achieved. Accordingly, if two targets are less than 75 mm apart, they cannot be distinguished from each other. The net effect is that the sonar system will display a single combined object, rather than multiple smaller objects, and hence fine sonar detail is lost.

CHIRP (Compressed High Intensity Radar Pulse) techniques can overcome this deficiency inherent in monotonic systems. CHIRP has long been used in commercial and military RADAR systems. The techniques used to create an electromagnetic CHIRP pulse have more recently been modified and adapted for acoustic imaging sonar systems. With CHIRP, instead of using a pulse of a single carrier frequency, the frequency within the burst is changed (swept) through the duration of the transmission, from one frequency to another. For example, at the start of the transmission the sonar may operate at 100 KHz, and at the end, it may have reached 150 KHz—the difference between the starting and ending frequency is known as the bandwidth of the transmission, and typically the center frequency of the sweep is used to designate the pulse. Thus, the noted example would be designated as a 125 KHz pulse.

By constantly changing its frequency over time, the chirped transmission has a unique acoustic signature, and therefore if two pulses overlap (when multiple targets are closer together than the range resolution), the known frequency-versus-time information can be used to discriminate between the targets.

Using high-speed digital-signal-processing (DSP) techniques, the sonar receiver can include a pattern-matching circuit that looks for the echo resulting from the transmitted CHIRP pulse, and the receiver can produce a sharp spike when a good match is found. In contrast, a monotonic sonar pulse would produce an output having the same duration as the transmit pulse. Thus, the critical factor in determining range resolution is no longer the pulse duration, but rather the bandwidth of the CHIRP. More particularly, the range resolution follows the equation Range Resolution=(Velocity of Sound)/(Bandwidth×2). As an example, assuming a typical 40 kHz bandwidth, and using the same VOS of 1500 meters/second, the range resolution is 18.75 mm, or about a quarter of that for monotonic sonar. With a chirped sonar, when two acoustic echoes overlap, the CHIRP pulses do not merge into a single acoustic return because their frequency is different from each other at the overlapping points, and the sonar is able to resolve and display the two targets.

Consequently, longer transmissions can be used to detect targets farther away without a loss in resolution. Furthermore, CHIRP signal processing techniques provide improvements in background noise rejection.

Sonar systems employing CHIRP have typically consisted of a CHIRP unit or module (also sometimes referred to as a “sounder” or “black box”) separate and distinct from the multi-function display (MFD). Improvements in sonar CHIRP-enabled systems are desired.

### BRIEF SUMMARY OF THE INVENTION

Embodiments of the present invention described herein relate to an improved CHIRP-enabled sonar system. The system includes a transducer having one or more transducer elements for receiving electrical transmission signals and converting the electrical transmission signals into acoustic pulses, and for receiving echo returns and converting acoustic energy of the echo returns into electrical return signals representative of the echo returns. The system further includes a multi-function display unit connected to the transducer so as to receive the electrical return signals representative of the echo returns. The multi-function display unit comprises a housing that accommodates a display unit having at least one visual display screen, and also accommodates a processor. The processor is configured to transmit the electrical transmission signals in the form of CHIRP signals. The processor is further configured to perform CHIRP processing on the electrical return signals to produce sonar data. The display unit is arranged to receive the sonar data and display the sonar data as images on the visual display screen.

In some embodiments the multi-function display unit further comprises a user interface. The user interface may include, for example, a keyboard, keypad, function keys, mouse, scrolling device, input/output ports, touch screen, or any other mechanism by which a user may interface with the system. In some cases the user interface may be formed in part or in whole by a portion of the display screen; for example, the display screen may be a touch screen.

In some embodiments the user interface includes a CHIRP selection operable to enable CHIRP mode when activated or disable CHIRP mode when deactivated.

The display unit can be configured to render data from sources of data including at least one of the group of radar, GPS, digital mapping, time, and temperature.

One or more of the display screens can be enabled to simultaneously provide different images representing different information from the processed electrical return signals.

In some embodiments, the multi-function display unit further comprises configuration settings defining a predefined set of display images that may be presented.

The transducer can be configured to operate at a selected one of at least two selectable operating frequencies.

The present disclosure also describes a CHIRP-enabled multi-function display unit for use in a sonar system having a transducer to receive electrical return signals representative of echo returns. The multi-function display unit comprises a housing that accommodates a display unit having at least one visual display screen, and also accommodates a processor, wherein the processor is configured to transmit electrical transmission signals in the form of CHIRP signals for causing a transducer to emit CHIRP pulses and is further configured to perform CHIRP processing on the electrical return signals to produce sonar data. The display unit is arranged to receive the sonar data and render the sonar data as images on the visual display screen.

In embodiments of the invention the display unit further comprises a user interface. The user interface in some embodiments includes a CHIRP selection operable to enable CHIRP mode of the processor when activated or disable CHIRP mode of the processor when deactivated.

In some embodiments the at least one display screen can be enabled to simultaneously provide different images representing different information from the processed electrical return signals.

The multi-function display unit can further include configuration settings defining a predefined set of display images that may be presented.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a sonar system, in accordance with example embodiments described herein.

### DETAILED DESCRIPTION OF THE INVENTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

Embodiments of the present invention are susceptible to use with a variety of sonar systems having various transducer arrangements and configurations, including those of commonly owned U.S. Pat. Nos. 8,305,840, 8,300,499, U.S. Patent Application Publication 2013/0021876, U.S. Patent Application Publication 2013/0016588, and U.S. Patent Application Publication 2012/0106300, all of which are hereby incorporated herein by reference in their entireties.

FIG. 1 is a basic block diagram illustrating a sonar system 30 capable for use with example embodiments of the present invention. The sonar system 30 may include a number of different modules or components, each of which may comprise any device or means embodied in either hardware, software, or a combination of hardware and software configured to perform one or more corresponding functions. For example, the sonar system 30 may include a CHIRP-enabled processor 32, a transceiver 34 and a transducer assembly 36. One or more of the components may be configured to communicate with one or more of the other components to process and/or display data, information or the like from one or more of the components. The components may also be configured to communicate with one another in any of a number of different manners including, for example, via a network device 40. In this regard, the network device may be any of a number of different communication backbones or frameworks including, for example, Ethernet, a NMEA 2000 framework, or other suitable network device. The network device may also support other data sources, including radar 42, a digital map 44, a GPS 46, autopilot, engine data, compass, a clock for time data, a temperature sensor for temperature data, etc.

In accordance with the invention, the system 30 includes a multi-function display unit 50. The multi-function display unit includes a housing 52. Accommodated within or by the housing are at least the CHIRP-enabled processor 32 and one or more display screens 38. The multi-function display unit can also include a user interface 39 configured to receive an input from a user.

The display screen(s) 38 may be configured to display images and may include or otherwise be in communication with the user interface 39. The display screen(s) 38 may be, for example, conventional LCD (liquid crystal display), touch screen(s), or any other suitable display devices known in the art upon which images may be rendered. Although each display screen 38 is shown as being connected to the processor 32 via the network device 40, the display screen could alternatively be in direct communication with the processor 32 in some embodiments. The user interface 39 may include, for example, function keys 41, a keyboard, keypad, mouse, scrolling device, input/output ports, touch screen, or any other mechanism by which a user may interface with the system. Moreover, in some cases, the user interface 39 may be a portion of one or more of the displays 38.

In an example embodiment, the transceiver 34 and network device 40 may also be accommodated within the housing 52 of the multi-function display unit 50. For example, in some cases, the transducer assembly 36 may simply be placed into communication with the multi-function display unit 50 (e.g., by connecting a cable from one to the other), which may itself be a mobile device that may be placed (but not necessarily mounted in a fixed arrangement) in the vessel to permit easy installation of the unit and so that the one or more displays 38 are viewable by an operator.

The user interface 39 may include a CHIRP selection, such as a function key 41, that activates or deactivates CHIRP functions in the processor 32. That is, when the user operates the CHIRP selection 41 to activate CHIRP functions, the processor 32 is then configured to operate in a CHIRP mode—i.e., to produce CHIRP transmission signals for supply to the transducer assembly 36, and to perform CHIRP processing on the electrical return signals from the transducer. When the user operates the CHIRP selection 41 to deactivate CHIRP functions, the processor 32 operates in a non-CHIRP mode.

The processor 32 may be any means such as a device or circuitry operating in accordance with software or otherwise embodied in hardware or a combination of hardware and software (e.g., a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 32 as described herein. In this regard, the processor 32 may be configured to analyze electrical signals communicated thereto by the transceiver 34 to provide sonar data indicative of the size, location, shape, etc. of objects detected by the sonar system 30. For example, the processor 32 may be configured to receive sonar return data and process the sonar return data to generate sonar image data for display to a user (e.g., on display 38).

In some cases, the processor 32 may include a processor, a processing element, a coprocessor, a controller or various other processing means or devices including integrated circuits such as, for example, an ASIC, FPGA or hardware accelerator, that is configured to execute various programmed operations or instructions stored in a memory device. The processor 32 may further or alternatively embody multiple compatible additional hardware or hardware and software items to implement signal processing or enhancement features to improve the display characteristics or data or images, collect or process additional data, such as time, temperature, GPS information, waypoint designations, or others, or may filter extraneous data to better analyze the collected data. It may further implement notices and alarms, such as those determined or adjusted by a user, to reflect depth, presence of fish, proximity of other watercraft, etc. Still further, the processor, in combination with suitable memory, may store incoming transducer data or screen images for future playback or transfer, or alter images with additional processing to implement zoom or lateral movement, or to correlate data, such as fish or bottom features to a GPS position or temperature. In an exemplary embodiment, the processor 32 may execute commercially available software for controlling the transceiver 34 and/or transducer assembly 36 and for processing data received therefrom.

The transceiver 34 may be any means such as a device or circuitry operating in accordance with software or otherwise embodied in hardware or a combination of hardware and software (e.g., a processor operating under software control or the processor embodied as an ASIC or FPGA specifically configured to perform the operations described herein, or a combination thereof) thereby configuring the device or circuitry to perform the corresponding functions of the transceiver 34 as described herein. In this regard, for example, the transceiver 34 may include (or be in communication with) circuitry for providing one or more transmission electrical signals to the transducer assembly 36 for conversion to sound pressure signals based on the provided electrical signals to be transmitted as a sonar pulse. The transceiver 34 may also include (or be in communication with) circuitry for receiving one or more electrical signals produced by the transducer assembly 36 responsive to sound pressure signals received at the transducer assembly 36 based on echo or other return signals received in response to the transmission of a sonar pulse. The transceiver 34 may be in communication with the processor 32 to both receive instructions regarding the transmission of sonar signals and to provide information on sonar returns to the processor 32 for analysis and ultimately for driving one or more of the displays 38 based on the sonar returns.

The transducer assembly 36 according to an exemplary embodiment may be provided in one or more housings that provide for flexible mounting with respect to a hull of the water craft or trolling motor on which the sonar system 30 is employed. In this regard, for example, the housing may be mounted onto the hull of the water craft or onto a device or component that may be attached to the water craft (e.g., a trolling motor or other steerable device, or another component that is mountable relative to the hull of the water craft), including a bracket that is adjustable on multiple axes, permitting rotation of the housing and/or the transducer elements contained therein.

The transducer assembly 36 may include one or more transducer elements positioned within the housing, as described in greater detail below. The transducer elements can convert electrical energy into sound energy (i.e., transmit) and also convert sound energy (e.g., via detected pressure changes) into an electrical signal (i.e., receive), although some transducers may act only as a hydrophone for converting sound energy into an electrical signal without operating as a transmitter, or only operating to convert an electrical signal into sound energy without operating as a receiver. Depending on the desired operation of the transducer assembly, each of the transducer elements may be configured to transmit sonar pulses and/or receive sonar returns as desired.

In some embodiments, the transducer assembly 36 may comprise a combination of transducer elements that are configured to transmit sonar pulses and receive sonar returns and transducer elements that are configured to receive sonar returns only.

In some embodiments, each transducer element may comprise any shape. The shape of a transducer element largely determines the type of beam that is formed when that transducer element transmits a sonar pulse (e.g., a circular transducer element emits a cone-shaped beam, a linear transducer emits a fan-shaped beam, etc.). In some embodiments, a transducer element may comprise one or more transducer elements positioned to form one transducer element. For example, a linear transducer element may comprise two or more rectangular transducer elements aligned with each other so as to be collinear. In some embodiments, three transducer elements aligned in a collinear fashion (e.g., end to end) may define one linear transducer element.

Likewise, transducer elements may comprise different types of materials that cause different sonar pulse properties upon transmission. For example, the type of material may determine the strength of the sonar pulse. Additionally, the type of material may affect the sonar returns received by the transducer element. As such, embodiments of the present invention are not meant to limit the shape or material of the transducer elements. Indeed, while depicted and described embodiments generally detail a square or linear transducer element made of piezoelectric material, other shapes and types of material are applicable to embodiments of the present invention.

In some embodiments, each transducer element may be configured to operate at any frequency, including operation over an array of frequencies. Along these lines, it should be understood that many different operating ranges could be provided with corresponding different transducer element sizes and shapes (and corresponding different beamwidth characteristics). Moreover, in some cases, the user interface 39 of the multi-function display unit 50 may include a variable frequency selector, to enable an operator to select a particular frequency of choice for the current operating conditions.

In some embodiments, the transducer element may define a linear transducer element, which may be configured to transmit sonar pulses and/or receive sonar returns within a volume defined by a fan-shaped beam. Such a fan-shaped beam may have a wide beamwidth in a direction substantially perpendicular to the longitudinal length of the transducer element and a narrow beamwidth in a direction substantially parallel to the longitudinal length of the transducer element.

Additionally, in some embodiments, the liner transducer element may be configured to operate in accordance with at least two operating frequencies. In this regard, for example, the frequency selection capability may enable the user to select one of at least two frequencies of operation. In one example, one operating frequency may be set to about 800 kHz and another operating frequency may be set to about 455 kHz. Furthermore, the length of the transducer elements may be set to about 204 mm (or approximately 8 inches) while the width is set to about 3 mm to thereby produce beam characteristics corresponding to a fan of about 0.8 degrees by about 32 degrees at 800 kHz or about 1.4 degrees by about 56 degrees at 455 kHz. For example, when operating at 455 kHz, the length and width of the transducer elements may be such that the beamwidth of sonar beam produced by the transducer elements in a direction parallel to a longitudinal length (L) of the transducer elements is less than about five percent as large as the beamwidth of the sonar beam in a direction (w) perpendicular to the longitudinal length of the transducer elements. As such, in some embodiments, any length and width for a transducer element may be used. Lengths longer than 8 inches may be appropriate at operating frequencies lower than those indicated above, and lengths shorter than 8 inches may be appropriate at frequencies higher than those indicated above.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A CHIRP-enabled sonar system, comprising:
a transducer having one or more transducer elements for receiving electrical transmission signals and converting the electrical transmission signals into acoustic pulses, and for receiving echo returns and converting acoustic energy of the echo returns into electrical return signals representative of the echo returns;
a multi-function display unit connected to the transducer so as to receive the electrical return signals representative of the echo returns, the multi-function display unit comprising a housing that accommodates a display unit having at least one visual display screen, and also accommodates a processor;
wherein the processor is configured to transmit the electrical transmission signals in the form of CHIRP signals and is further configured to perform CHIRP processing on the electrical return signals to produce sonar data, and the display unit is arranged to receive the sonar data and render the sonar data as images on the visual display screen.

2. The CHIRP-enabled sonar system of claim 1, wherein the display unit further comprises a user interface.

3. The CHIRP-enabled sonar system of claim 2, wherein the user interface includes a CHIRP selection operable to enable CHIRP processing by the processor when activated or disable CHIRP processing by the processor when deactivated.

4. The CHIRP-enabled sonar system of claim 1, wherein the display unit is configured to render data from sources of data including at least one of the group of radar, GPS, digital mapping, time, and temperature.

5. The CHIRP-enabled sonar system of claim 1, wherein the at least one display screen is enabled to simultaneously provide different images representing different information from the processed electrical return signals.

6. The CHIRP-enabled sonar system of claim 1, wherein the multi-function display unit further comprises configuration settings defining a predefined set of display images that may be presented.

7. The CHIRP-enabled sonar system of claim 1, wherein the transducer is configured to operate at a selected one of at least two selectable operating frequencies.

8. A CHIRP-enabled multi-function display unit for use in a sonar system having a transducer to receive electrical return signals representative of echo returns, the multi-function display unit comprising a housing that accommodates a display unit having at least one visual display screen, and also accommodates a processor, wherein the processor is configured to transmit electrical transmission signals in the form of CHIRP signals for causing a transducer to emit CHIRP pulses and is further configured to perform CHIRP processing on the electrical return signals to produce sonar data, and the display unit is arranged to receive the sonar data and render the sonar data as images on the visual display screen.

9. The CHIRP-enabled multi-function display unit of claim 8, wherein the display unit further comprises a user interface.

10. The CHIRP-enabled multi-function display unit of claim 9, wherein the user interface includes a CHIRP selection operable to alternatively enable CHIRP processing when activated or disable CHIRP processing when deactivated.

11. The CHIRP-enabled multi-function display unit of claim 8, wherein the display unit is configured to render data from sources of data including at least one of the group of radar, GPS, digital mapping, time, and temperature.

12. The CHIRP-enabled multi-function display unit of claim 8, wherein the at least one display screen is enabled to simultaneously provide different images representing different information from the processed electrical return signals.

13. The CHIRP-enabled multi-function display unit of claim 8, wherein the multi-function display unit further comprises configuration settings defining a predefined set of display images that may be presented.
